(19) United States
(12) Patent Application Publication
(10) Pub. No.: US 2009/0265520 A1
(43) Pub. Date: Oct. 22, 2009

(54) METHOD AND APPARATUS FOR BACKING UP DATA

(76) Inventors: Weihua Geng, Shenzhen (CN); Hua Peng, Shenzhen (CN); Peng Zhang, Shenzhen (CN); Guobin Zhang, Shenzhen (CN); Yangji OU, Shenzhen (CN)

Correspondence Address: BRINKS HOFER GILSON & LIONE, P.O. BOX 10395, CHICAGO, IL, 60610, US

(21) Appl. No.: 12/351,466

(22) Filed: Jan. 9, 2009

(30) Foreign Application Priority Data
Apr. 18, 2008 (CN) 200810087593.4

(51) Int. Cl. G06F 12/16; G06F 12/00

(52) U.S. Cl. 711/162; 711/E12.001; 711/E12.103

(57) ABSTRACT

A method and apparatus for backing up data in the source LUN is disclosed. The method for backing up the data in a source Logic Unit Number (LUN), includes: copying the data which needs to be modified in the source LUN to a resource pool; monitoring the resource utilization amount in the resource pool; creating a target LUN when the resource utilization amount exceeds a preset threshold; and copying the unmodified data in the source LUN and the backup data of the source LUN in the resource pool into the target LUN.

This application claims the benefit of priority to Chinese Patent Application No. 200810087593.4, filed on Apr. 18, 2008, the disclosure of which is hereby incorporated by reference herein in its entirety.

### FIELD OF THE INVENTION

The present disclosure relates to the field of data storage technologies, and in particular, to a method and apparatus for backing up data.

### BACKGROUND OF THE INVENTION

Currently, a data snapshot technology and a data copy technology are generally used to back up the original data in a source Logic Unit Number (LUN) and prevent data loss. In the data snapshot technology, the general method for modifying data is: copying the data that needs to be modified in the source LUN into a resource pool before modification, pointing one pointer in an entry of a mapping table to the storage location of such data in the resource pool, and pointing another pointer in the same entry of the mapping table to such data in the source LUN, wherein the mapping table indicates the actual data storage location of the snapshot. It is thus evident that the snapshot LUN is a real-time consistent mapping of some data in the source LUN. In the snapshot LUN, some data is stored in the resource pool, and other data is stored in the source LUN. Generally, the resource pool is shared by many snapshot sessions. Then, in this method, when a snapshot occupies plenty of storage resources in the resource pool, the resource pool is probably unable to fulfill the requirements of other snapshot sessions.

Besides, the general method for copying data in the related art is: backing up all data on the source LUN to the target LUN completely. In this way, when the source LUN is damaged, the target LUN can be used directly to recover the data completely. In this method, plenty of storage resources are occupied, and it takes a long time to copy all data in the source LUN.

### SUMMARY OF THE INVENTION

A method for backing up data in another embodiment of the present disclosure includes: monitoring the resource utilization amount of the resource pool; judging whether a resource utilization amount of the resource pool exceeds a preset threshold; if the resource utilization amount is less than or equal to the preset threshold, copying data to be modified in a source Logic Unit Number, LUN, to a resource pool as backup data for the data to be modified in the source LUN; and if the resource utilization amount exceeds the preset threshold, creating a target LUN and copying unmodified data in the source LUN and the backup data in the resource pool to the target LUN.

An embodiment of the present disclosure also discloses an apparatus for backing up data. The apparatus for backing up data includes a snapshot LUN unit, configured to copy the data that need to be modified in the source LUN to the resource pool; a monitoring unit, configured to monitor a resource utilization amount in the resource pool, and trigger a copying command when the resource utilization amount in the resource pool exceeds a resource threshold; a LUN copying unit, configured to create a target LUN after receiving the copying command of the monitoring unit, and copy unmodified data in the source LUN and backup data in the resource to the target LUN.

An embodiment of the present disclosure also discloses a computer readable medium readable by a machine, a program of instructions executable by the machine to perform a data backup method. The data backup method includes at least the following: monitoring the resource utilization amount of the resource pool; judging whether a resource utilization amount of the resource pool exceeds a preset threshold; if the resource utilization amount is less than or equal to the preset threshold, copying data to be modified in a source Logic Unit Number, LUN, to a resource pool as backup data for the data to be modified in the source LUN; and if the resource utilization amount exceeds the preset threshold, creating a target LUN and copying unmodified data in the source LUN and the backup data in the resource pool to the target LUN.

### BRIEF DESCRIPTION OF THE DRAWINGS

FIG. 1 is a block diagram of a backup method in an embodiment of the present disclosure;

FIG. 2 is a block diagram of a backup method in another embodiment of the present disclosure;

FIG. 3 shows a primary system structure of a snapshot primary storage system in an embodiment of the present disclosure;

FIG. 4 shows a primary system structure sketch when a few snapshots are created in another embodiment of the present disclosure;

FIG. 5 shows a primary system structure sketch when multiple snapshots are created in another embodiment of the present disclosure;

FIG. 6 is a block diagram of a backup apparatus in an embodiment of the present disclosure; and

FIG. 7 is a block diagram of a backup apparatus in another embodiment of the present disclosure.

### DETAILED DESCRIPTION OF THE INVENTION

Embodiments of the present disclosure are hereinafter described in detail with reference to embodiments and accompanying drawings.

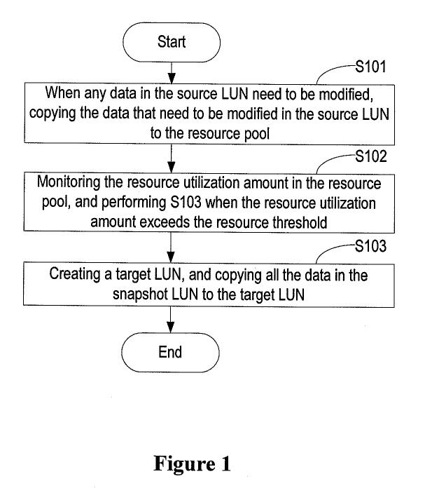

The data backup method disclosed by an embodiment of the present disclosure decides whether to store the original data of the modified part or back up all data in the source LUN according to the resource utilization amount of the resource pool that stores data of the source LUN. Before implementing the present disclosure, it is necessary to set a threshold of resource utilization amount for the resource pool (hereinafter referred to as “resource threshold”) as a measure of the resource utilization amount in the resource pool. FIG. 1 is a flowchart of a data backup method in an embodiment of the present disclosure. The method includes:

S101: When any data in the source LUN needs to be modified, the data that needs to be modified in the source LUN is copied to the resource pool by using a data snapshot technology, and then the data in the source LUN is modified.

S102: The resource utilization amount of the resource pool is monitored, and it is judged whether the resource utilization amount of the resource pool exceeds the threshold. If the threshold is exceeded, S103 is performed.

S103: A target LUN is created, and the data unmodified in the source LUN is backed up to the target LUN; and the backup data of the source LUN in the resource pool is copied to the target LUN. In this way, all the data in the snapshot LUN is copied to the target LUN rather than one part being stored in the source LUN and the other part in the resource pool.

In S103, the data in the virtual snapshot LUN is backed up to a physical target LUN after the utilization amount of the resource pool reaches a certain amount. It is thus understandable that the copying technology in S103 is different from the related art which backs up the data from the source LUN to the target LUN directly. For ease of description, the backup method in S103 is called “hot backup”.

In the foregoing embodiment, when any data in the source LUN needs to be modified, the data that needs to be modified may be copied to the resource pool first, namely, the data is backed up to the snapshot LUN through a data snapshot technology. Meanwhile, the resource utilization amount of the resource pool is tracked. When the resource utilization amount of the resource pool reaches a certain proportion, the data is copied from the virtual snapshot LUN to the physical target LUN through the hot backup method. Therefore, the data is backed up completely to avoid loss of the original data in the source LUN.

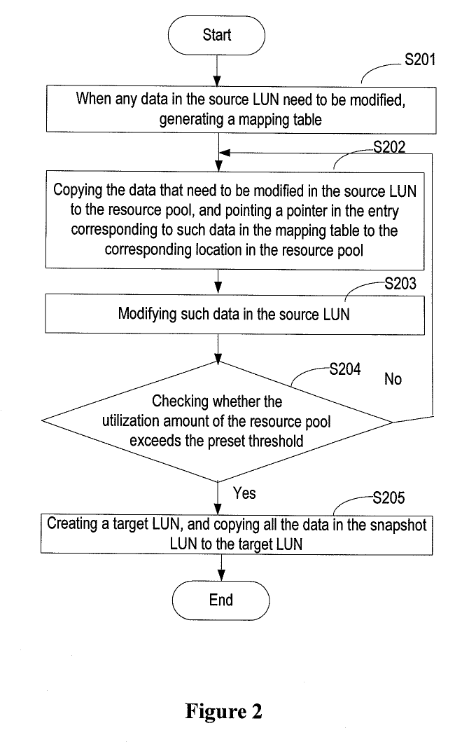

The data backup method under the present disclosure is described below in detail through examples. FIG. 2 is a flowchart of a data backup method in another embodiment of the present disclosure. The method includes:

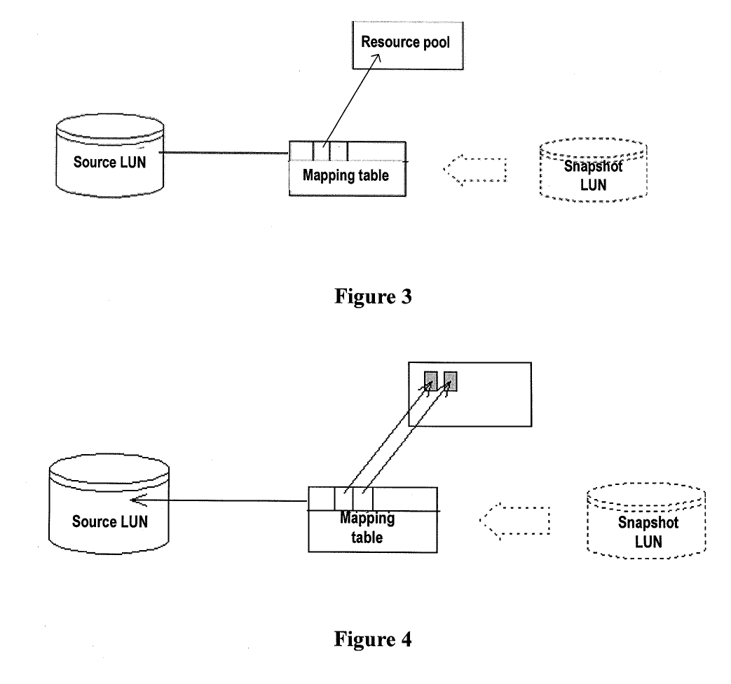

S201: When any data in the source LUN needs to be modified, a mapping table which indicates the actual location for storing the data is generated. The pointer of a newly created mapping table is generally pointed to the source LUN. FIG. 3 shows a primary system structure for creating a snapshot.

S202: The data that needs to be modified in the source LUN is copied to the resource pool, one pointer in an entry indicative of such data in the mapping table is modified into a location for storing such data in the resource pool, and another pointer in the entry is pointed into the location of such data in the source LUN, as shown in FIG. 3.

Before performing the process of the method under this embodiment of the present disclosure, a resource threshold, for example, 0.8 in this embodiment, needs to be preset for the resource pool.

S203: Such data in the source LUN is modified.

S204: The resource utilization amount in the resource pool is monitored, and it is judged whether the resource utilization amount of the resource pool exceeds the threshold. If the threshold is exceeded, the process proceeds to S205; otherwise, the process goes back to S202.

For example, in FIG. 4, two parts of data are stored in the resource pool. Accordingly, two entries are created in the mapping table. Therefore, the resource utilization amount in the resource pool is 0.2, which does not exceed the threshold, so S102 and S103 may be repeated.

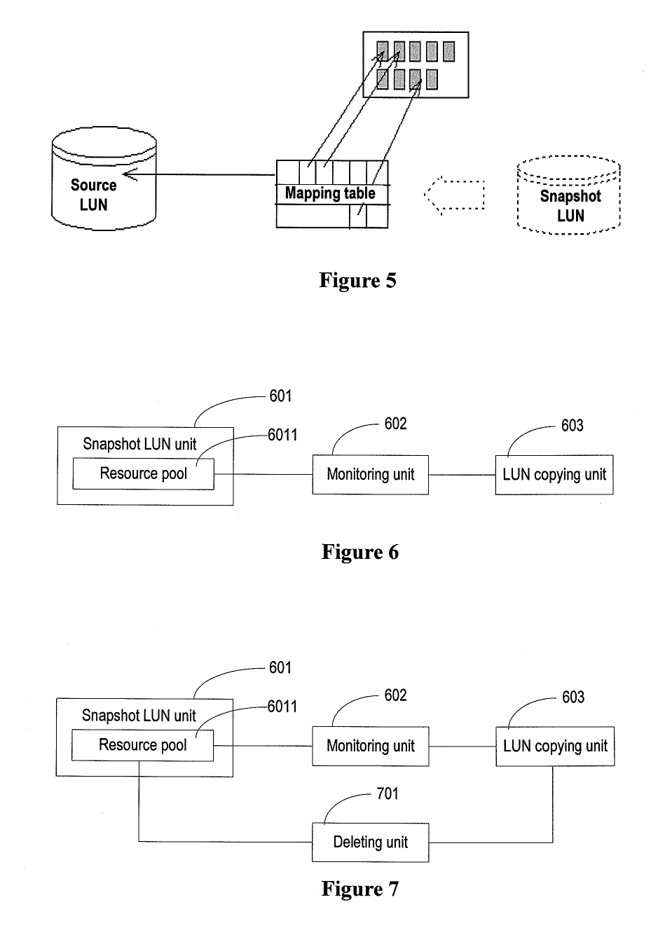

In another scenario, plenty of data is backed up in the resource pool. For example, in FIG. 5, nine parts of data are stored in the resource pool. Accordingly, nine entries are created in the mapping table. Therefore, the resource utilization amount in the resource pool is 0.9, which exceeds the threshold 0.8, so the process proceeds to S205.

S205: A target LUN is created, and the unmodified data in the source LUN is backed up to the target LUN; meanwhile, the backup data in the resource pool corresponding to the modified data of the source LUN is copied to the target LUN. In this way, all the data in the snapshot LUN is copied to the target LUN rather than a part being stored in the source LUN and another part being stored in the resource pool.

The foregoing embodiment is only an example of the method, and the sequence is not limited to the foregoing process. For example, S204 may be performed between S201 and S202. In other words, when the data in the source LUN needs to be modified, a judgment is made as regards whether the resource utilization amount of the resource pool exceeds the threshold before the data is modified. In this way, when the resources in the resource pool are not enough for fulfilling the backup requirements, S205 may be performed directly to copy the data in the source LUN to the target LUN against loss of the original data in the source LUN.

Alternatively, S204 is performed after S202 and S203 are performed for a certain number of times, where the number of times may be set to an experiential value.

Besides, before S202, a judgment may be made as regards whether there is a pointer in an entry which is corresponding to the data to be modified in the mapping table points to the resource pool. If so, S202 may be skipped and the process proceeds to S203 directly; if not, the process proceeds to S202 and subsequent processes.

Moreover, because a complete backup is generated in S205, the backup related to the source LUN may be deleted in the resource pool after S205 is finished in order to release the storage resources for other snapshot sessions.

In the foregoing embodiment, when any data in the source LUN needs to be modified, the data that needs to be modified may be copied to the resource pool first, namely, the data is backed up to the snapshot LUN through a data snapshot technology. Meanwhile, resource utilization amount of the resource pool is tracked. When the resources occupied by the backup data in the resource pool reach a preset threshold, it indicates that plenty of data has been modified in the source LUN, and the data in the source LUN are sharply different from the data in the resource pool. In this case, original data in the source LUN may be copied from the virtual snapshot LUN to the physical target LUN, so that the source LUN is backed up completely to avoid loss of the original data in the source LUN.

The present disclosure accomplishes intelligent conversion between virtual snapshot and physical copying according to the utilization of the resource pool. Therefore, the merits of both virtual snapshot and physical copying are drawn upon efficiently. In other words, when few data is modified, the least storage resources are consumed; when plenty of data is modified, a complete backup is generated to ensure integrity of the original data.

Besides, in the present disclosure, the backup data of the source LUN may be deleted to release the resources in the resource pool after S205 is performed. Therefore, the capacity of the resource pool keeps at a certain level available to other snapshot sessions.

Based on the foregoing technical solution, an embodiment of the present disclosure discloses an apparatus for backing up storage data in a source LUN. As shown in FIG. 6, the apparatus includes a snapshot LUN unit 601, a monitoring unit 602, and a copying LUN unit 603, as described hereinafter.

The snapshot LUN unit 601 includes a resource pool 6011 configured to store some data in the source LUN. The snapshot LUN unit 601 is configured to copy the data that needs to be modified in the source LUN to the resource pool 6011. A resource threshold (for example, 0.8) is preset to measure the resource utilization amount of the resource pool 6011.

The data copied to the resource pool may be detailed as: for example, in the mapping table corresponding to the resource pool 6011, one pointer in the entry corresponding to such data points to the location of backup of such data in the resource pool 6011, and another pointer in the entry points to the location of such data in the source LUN. In this case, a monitoring unit 602 may be started to monitor the resource utilization amount in the resource pool 6011. The monitoring unit 602 judges whether the resource utilization amount in the resource pool 6011 exceeds the resource threshold (for example, 0.8). If the threshold is exceeded, a copying command is triggered.

The LUN copying unit 603 is configured to: create a target LUN after receiving the copying command of the monitoring unit 602, and back up the data unmodified in the source LUN to the target LUN; meanwhile, copy the backup data corresponding to the modified part of the source LUN in the resource pool to the target LUN.

Moreover, the present disclosure discloses another apparatus embodiment. FIG. 7 is a block diagram that shows the structure of an apparatus in another embodiment of the present disclosure. On the basis of the apparatus embodiment shown in FIG. 6, after the LUN copying unit 603 finishes copying the data, this apparatus further includes: a deleting unit 701, configured to delete the backup data of the source LUN in the resource pool 6011 after the LUN copying unit 603 finishes copying in order to release storage resources for other snapshot sessions.

In the foregoing apparatus embodiment, when the data in the source LUN needs to be modified, a snapshot LUN unit 601 may be used to copy the part that needs to be modified to the resource pool 6011 first. Meanwhile, a monitoring unit 602 is used to track the resource utilization amount in the resource pool 6011 and control when to use the LUN copying unit 603 to back up the data completely. The present disclosure accomplishes conversion between virtual snapshot and physical copying according to the utilization of the resource pool. Therefore, the merits of both virtual snapshot and physical copying are drawn upon efficiently. In other words, when few data is modified, the least storage resources are consumed; when plenty of data is modified, a complete backup is generated to ensure integrity of the original data.

Moreover, in an embodiment of the present disclosure, the resources in the resource pool 6011 may be released through a deleting unit 701 so that the resources are available to other snapshot sessions, after the data is copied completely.

On the basis of the apparatus shown in FIG. 6 and FIG. 7, the present disclosure also discloses a disk array. The disk array includes the units of the apparatus shown in FIG. 6 and FIG. 7. The functions and connection relations of the units are the same as those of the apparatus shown in FIG. 6 and FIG. 7, and are not repeated here any further.

Moreover, on the basis of the apparatus shown in FIG. 6 and FIG. 7, the present disclosure also discloses a server. The server includes a disk array, which includes the units of the apparatus shown in FIG. 6 and FIG. 7. The functions and connection relations of the units are the same as those of the apparatus shown in FIG. 6 and FIG. 7, and are not repeated here any further.

The apparatuses described above are for illustration only. The unit described above as a separate component may be physically separated or not. The component displayed as a unit may be a physical unit or not. The components can be located in a place or distributed onto multiple network units. The users can select part or all of the modules at their own discretion to fulfill the purposes of the embodiments of the present disclosure. Ordinary technicians in this field can understand and implement the technical solutions without making any creative effort.

After study of the above embodiments, those skilled in the art understand that the disclosure may be realized through software and general hardware platforms or through hardware only. Based on such understandings, the technical solution provided in embodiments of the disclosure or contributions to the related art can be embodied in software products. The software is stored in a storage medium (for example, ROM/RAM, disk, and CD) and incorporates several instructions to instruct a computer device (for example, PC, server, or network device) to execute the method provided in the embodiments of the present disclosure.

The embodiments described above are only better ones of this disclosure, and they are not used to confine the protection scope of this disclosure. It is apparent that those skilled in the art can make various modifications and variations to the disclosure without departing from the spirit and scope of the disclosure.

What we claim is:

1. A data backup method, comprising:
monitoring a resource utilization amount of a resource pool;
judging whether the resource utilization amount of the resource pool exceeds a preset threshold; and
if the resource utilization amount is less than or equal to the preset threshold, copying data to be modified in a source Logic Unit Number (LUN), to a resource pool; or
if the resource utilization amount exceeds the preset threshold, creating a target LUN, and copying unmodified data in the source LUN and data in the resource pool to the target LUN.

2. The data backup method according to claim 1, wherein after copying unmodified data in the source LUN and data in the resource pool to the target LUN, the data backup method further comprises: deleting the data in the resource pool.

3. An apparatus for backing up data, comprising:
a snapshot Logical Unit Number (LUN) unit;
a monitoring unit; and
a LUN copying unit,
wherein:
the snapshot LUN unit comprises a resource pool;
the snapshot LUN unit is configured to copy data to be modified in a source LUN to a resource pool when a resource utilization amount in the resource pool is less than or equal to a preset resource threshold;
the monitoring unit is configured to monitor the resource utilization amount in the resource pool and trigger a copying command when the resource utilization amount of the resource pool exceeds the preset resource threshold; and,
the LUN copying unit is configured to create a target LUN after receiving the copying command of the monitoring unit, and copy unmodified data in the source LUN and backup data in the resource pool to the target LUN.

4. The apparatus for backing up data according to claim 3, wherein the apparatus is a disk array or a server.

5. The apparatus for backing up data according to claim 3, wherein the apparatus further comprises:
a deleting unit, configured to delete the backup data in the resource pool after the LUN copying unit finishes copying the unmodified data in the source LUN and the backup data in the resource pool to the target LUN.

6. The apparatus for backing up data according to claim 5, wherein the apparatus is a disk array or a server.

7. A computer readable medium storing a program of instructions executable by a computer to perform a data backup method, the method comprising:
monitoring a resource utilization amount of a resource pool;
judging whether the resource utilization amount of the resource pool exceeds a preset threshold; and
if the resource utilization amount is less than or equal to the preset threshold, copying data to be modified in a source Logic Unit Number, LUN, to the resource pool; or
if the resource utilization amount exceeds the preset threshold, creating a target LUN and copying unmodified data in the source LUN and the data in the resource pool to the target LUN.

8. The computer readable medium according to the claim 7, wherein data backup method further comprises: deleting the data in the resource pool.
